(19) United States
(12) Patent Application Publication
(10) Pub. No.: US 2015/0301764 A1
(43) Pub. Date: Oct. 22, 2015

(54) Hard Disk and Methods for Forwarding and Acquiring Data by Hard Disk

(71) Applicant: Huawei Technologies Co., Ltd., Shenzhen (CN)

(72) Inventors: Kun Tang, Chengdu (CN); Dechun Bi, Chengdu (CN); Jun Wang, Shenzhen (CN)

(21) Appl. No.: 14/753,242

(22) Filed: Jun. 29, 2015

Related U.S. Application Data
(63) Continuation of application No. PCT/CN2014/071038, filed on Jan. 22, 2014.

(30) Foreign Application Priority Data
Jul. 2, 2013 (CN) 201310275096.8

(51) Int. Cl. G06F 3/06; G06F 13/42

(52) U.S. Cl. CPC G06F 3/0659; G06F 3/061; G06F 3/067; G06F 13/4221

(57) ABSTRACT

A hard disk and methods for forwarding and acquiring data implemented by a hard disk. The hard disk includes: a storage module, configured to store data; an interaction interface, configured to implement data interaction between the hard disk and an external device; and a data control module, configured to control, by using the interaction interface, data interaction between the hard disk and the external device. In a process of performing backup implemented by the hard disk, a write data operation does not need to be performed on each backup hard disk when a server performs data backup by using the hard disk, which reduces operations performed by the server and releases resources of the server.

### CROSS-REFERENCE TO RELATED APPLICATION

This application is a continuation of International Application No. PCT/CN2014/071038, filed on Jan. 22, 2014, which claims priority to Chinese Patent Application No. 201310275096.8, filed on Jul. 2, 2013, both of which are incorporated herein by reference in their entireties.

### TECHNICAL FIELD

The present invention relates to the field of computer and network technologies, and in particular, to a hard disk and methods for forwarding and acquiring data by a hard disk.

### BACKGROUND

Currently, with the development of computer network technologies, a cloud storage technology is becoming a main trend of the storage industry, and the cloud storage technology requires a hard disk that features a large capacity and a low price and can be connected by using a network. However, hard disks commonly used in the prior art include a Serial Attached Small Computer System Interface (SAS) hard disk and a Serial Advanced Technology Attachment (SATA) hard disk. These hard disks can implement a network function by using controllers and extenders, which increases an additional cost.

A cloud server in the prior art is generally connected to a hard disk in the following two manners.

1. The cloud server is connected to a network storage device by using a network switch, and the cloud server needs to convert data that is written to a hard disk medium into a network-based packet. The packet is forwarded, by using a network, to the Internet Protocol (IP)-based network storage device; and the network storage device reorganizes the network-based packet to be a Small Computer System Interface (SCSI) command, and sends the SCSI command to a SAS hard disk or a SATA hard disk by using a SAS link.

2. The cloud server is connected to a storage device by using a Fiber Channel (FC); the cloud server needs to convert data that is written to a hard disk medium to a SCSI command, and then converts the SCSI command to a data frame transmitted on the FC; and a network storage device receives the FC data frame, converts the FC data frame to a SCSI command, and sends the SCSI command to a SAS hard disk or a SATA hard disk by using a SAS link.

A typical backup mechanism of the cloud server is that three copies are saved in a hard disk to ensure data reliability. During a backup process, the cloud server needs to perform a write data operation on each copy, and the write data operation needs to be performed three times, which occupies more resources of the cloud server.

### SUMMARY

Embodiments of the present invention provide a hard disk and methods for forwarding and acquiring data by a hard disk, to resolve a problem in the prior art that cloud backup occupies resources of a cloud server.

To resolve the foregoing technical problem, the embodiments of the present invention disclose the following technical solutions.

According to a first aspect, a hard disk is provided, where the hard disk includes a storage module configured to store data, an interaction interface configured to implement data interaction between the hard disk and an external device, and a data control module configured to control, by using the interaction interface, data interaction between the hard disk and the external device.

In a first possible implementation manner of the first aspect, the external device is an external computer or an external hard disk.

In a second possible implementation manner of the first aspect, the interaction interface is a SAS interface, a SATA interface, a universal serial bus (USB) interface, or a wireless network interface.

In a third possible implementation manner of the first aspect, the interaction interface is an Internet Small Computer System Interface (iSCSI) and configured to receive, disassemble, assemble, and send iSCSI data.

In a fourth possible implementation manner of the first aspect, the data control module includes a data forwarding unit configured to forward the data stored in the storage module to an external hard disk.

In a fifth possible implementation manner of the first aspect, the data forwarding unit further includes a forwarding command receiving subunit configured to receive a forwarding request and forwarding configuration information, a forwarding control subunit configured to control a data forwarding process, and a forwarding status feedback subunit configured to feed back a state in which the hard disk forwards the data.

In a sixth possible implementation manner of the first aspect, the data control module includes a data acquiring unit configured to acquire data from the external device and store the data in the storage module.

According to a second aspect, a method for forwarding data implemented by a hard disk is provided, where the method includes receiving data, and storing the data and forwarding the data to an external device.

In a first possible implementation manner of the second aspect, the method further includes a step of receiving a forwarding request and forwarding configuration information.

In a second possible implementation manner of the second aspect, the method further includes a step of feeding back a state in which the hard disk forwards the data.

In a third possible implementation manner of the second aspect, the data is forwarded to the external device at the same time when the data is stored.

In a fourth possible implementation manner of the second aspect, the data is forwarded to the external device after the data is stored.

According to a third aspect, a method for acquiring data implemented by a hard disk is provided, where the method includes receiving a data acquiring command, establishing a data connection with an external device, and acquiring required data.

In a first possible implementation manner of the third aspect, the external device is an external hard disk.

In a second possible implementation manner of the third aspect, the data acquiring command includes a network address of the external device.

According to the hard disk in the embodiments of the present invention, an interaction interface and a data control module are added to the hard disk, so that the hard disk may actively implement a function of data interaction; therefore, a write data operation does not need to be performed on each backup hard disk when a server performs data backup by using the hard disk, which reduces operations performed by the server and greatly releases resources of the server. The method for forwarding data implemented by a hard disk in the embodiments of the present invention is a method for forwarding data by using the foregoing hard disk to implement data backup; and the method for acquiring data implemented by a hard disk in the embodiments of the present invention is a method for acquiring data from an external device by using the foregoing hard disk to implement data backup. Both of the foregoing two methods may implement automatic backup of the hard disk, reduce operations performed by the server, and release resources of the server.

### BRIEF DESCRIPTION OF DRAWINGS

To describe the technical solutions in the embodiments of the present invention more clearly, the following briefly introduces the accompanying drawings required for describing the embodiments. The accompanying drawings in the following description show some embodiments of the present invention, and persons of ordinary skill in the art may still derive other drawings from these accompanying drawings without creative efforts.

FIG. 1 is a schematic structural diagram of a hard disk according to an embodiment of the present invention.

FIG. 2 is a schematic diagram of a connection architecture between a server and a hard disk according to an embodiment of the present invention.

FIG. 3 is a schematic structural diagram of a data forwarding unit according to an embodiment of the present invention.

FIG. 4 is a schematic flowchart of a first method for forwarding data implemented by a hard disk according to an embodiment of the present invention.

FIG. 5 is a schematic flowchart of a second method for forwarding data implemented by a hard disk according to an embodiment of the present invention.

FIG. 6 is a schematic flowchart of a third method for forwarding data implemented by a hard disk according to an embodiment of the present invention.

FIG. 7 is a schematic flowchart of a method for acquiring data implemented by a hard disk according to an embodiment of the present invention.

FIG. 8 is a schematic flowchart of interaction between a server and a hard disk according to Embodiment 1 of the present invention.

FIG. 9 is a schematic flowchart of interaction between a server and a hard disk according to Embodiment 2 of the present invention.

### DESCRIPTION OF EMBODIMENTS

To make the objectives, technical solutions, and advantages of the embodiments of the present invention clearer, the following clearly describes the technical solutions in the embodiments of the present invention with reference to the accompanying drawings in the embodiments of the present invention. The described embodiments are a part rather than all of the embodiments of the present invention.

With reference to the accompanying drawings and the embodiments, the following further describes in detail specific implementation manners of the present invention. The following embodiments are used for illustrating the present invention, but not limiting the scope of the present invention.

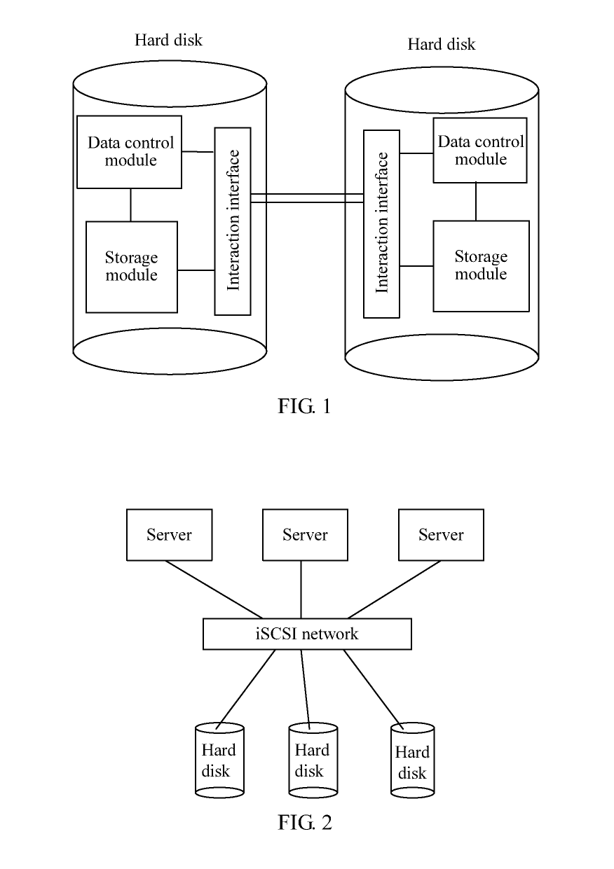

As shown in FIG. 1, according to a first aspect, a hard disk is provided, where the hard disk includes a storage module configured to store data, an interaction interface configured to implement data interaction between the hard disk and an external device, and a data control module configured to control, by using the interaction interface, data interaction between the hard disk and the external device.

The external device may be an external computer or an external hard disk; and the interaction interface may be a SAS interface, a SATA interface, a USB interface, or a wireless network interface.

As shown in FIG. 2, the interaction interface may also be an iSCSI and configured to receive, disassemble, assemble, and send iSCSI data. When the interaction interface is an iSCSI, the iSCSI may enable the hard disk to directly connect to a server and another hard disk that are on an iSCSI network; therefore, a storage architecture of network storage is simplified, and storage efficiency is improved.

The data control module may include a data forwarding unit configured to forward the data stored in the storage module to an external hard disk.

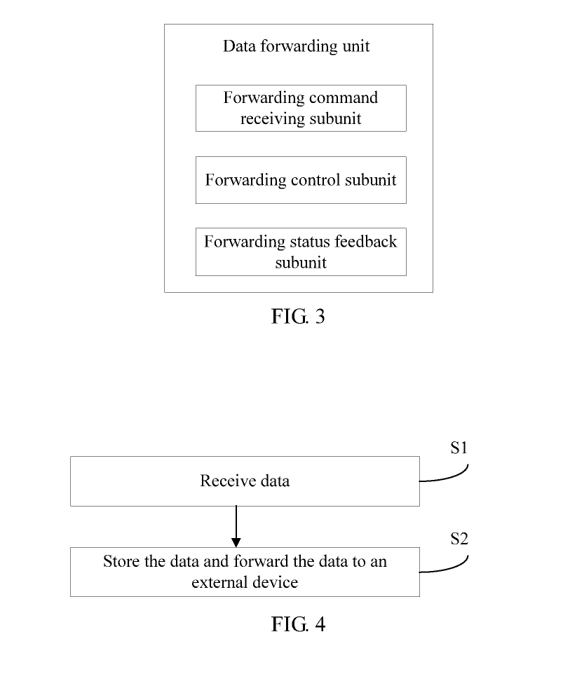

As shown in FIG. 3, the data forwarding unit may include a forwarding command receiving subunit configured to receive a forwarding request and forwarding configuration information, a forwarding control subunit configured to control a data forwarding process, and a forwarding status feedback subunit configured to feed back a state in which the hard disk forwards the data.

The forwarding request and the forwarding configuration information received by the forwarding command receiving subunit may be set by a user by using a network server, and sent by the network server to the hard disk. The state in which the hard disk forwards the data includes three states: forwarding not started, being forwarded, and forwarding completed.

Certainly, an implementation manner in which the hard disk forwards data to perform backup is corresponding to an implementation manner in which the hard disk acquires data from the external device to perform backup. In an embodiment of the present invention, the data control module includes a data acquiring unit configured to acquire data from the external device and store the data in the storage module. This manner may also implement a function of data backup.

As shown in FIG. 4, according to a second aspect, a method for forwarding data implemented by a hard disk is provided, where the method includes the following steps.

S1: Receive data.

S2: Store the data and forward the data to an external device.

The foregoing method is used in a case in which data received by a hard disk needs to be forwarded and backed up to a backup hard disk and the backup hard disk has been specified.

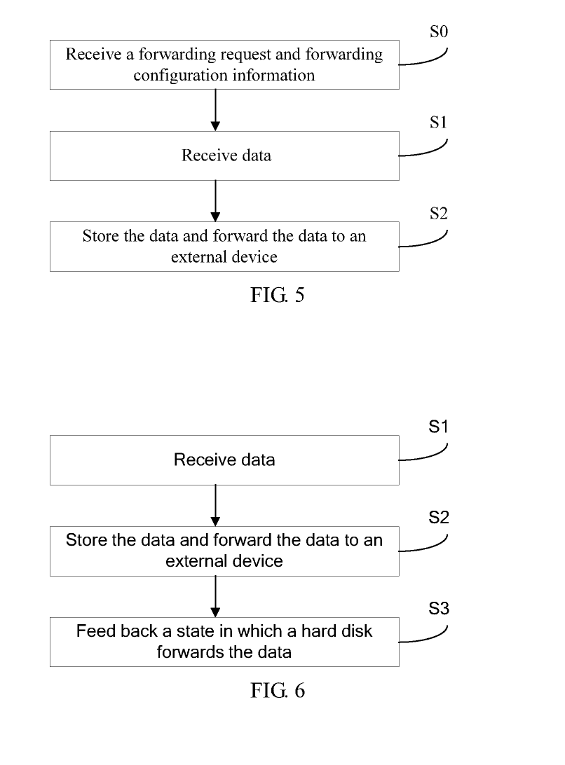

Certainly, the hard disk may determine, by receiving a forwarding request, whether to perform forwarding. In this case, the forwarding method may further include step S0: Receive a forwarding request and forwarding configuration information. As shown in FIG. 5, the method for forwarding data implemented by a hard disk includes the following steps.

S0: Receive a forwarding request and forwarding configuration information.

S1: Receive data.

S2: Store the data and forward the data to an external device.

After forwarding the data to a backup hard disk, the hard disk may feed back a state in which the hard disk forwards the data to a party that sends the request. In this case, as shown in FIG. 6, the method for forwarding data implemented by a hard disk includes the following steps.

S1: Receive data.

S2: Store the data and forward the data to an external device.

S3: Feed back a state in which the hard disk forwards the data.

Forwarding modes of the hard disk include a synchronous forwarding mode and an asynchronous forwarding mode.

In the synchronous forwarding mode of the hard disk, in the step S2 of the method for forwarding data implemented by a hard disk, the data is forwarded to the external device at the same time when the data is stored.

In the asynchronous forwarding mode of the hard disk, in the step S2 of the method for forwarding data implemented by a hard disk, the data is forwarded to the external device after the data is stored.

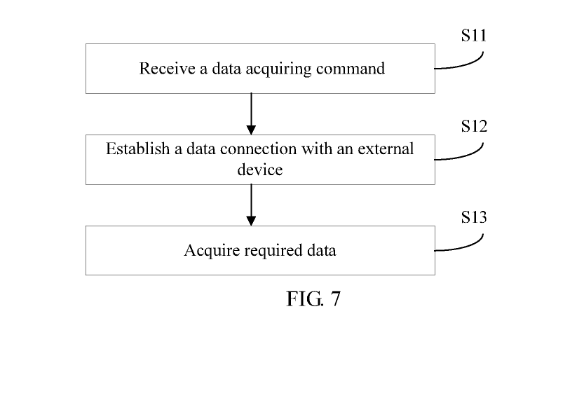

A method corresponding to the method for forwarding data implemented by a hard disk is acquiring, by a hard disk, data from an external device to perform backup. As shown in FIG. 7, the foregoing method for acquiring data implemented by a hard disk may include the following steps.

S11: Receive a data acquiring command.

S12: Establish a data connection with an external device.

S13: Acquire required data.

The external device may be an external hard disk, and the data acquiring command may include a network address of the external device, so that a data connection is established with the external device in subsequent steps.

The following illustrates, by using embodiments, specific implementation processes of the hard disk, the method for forwarding data implemented by a hard disk, and the method for acquiring data implemented by a hard disk according to the present invention.

### Embodiment 1

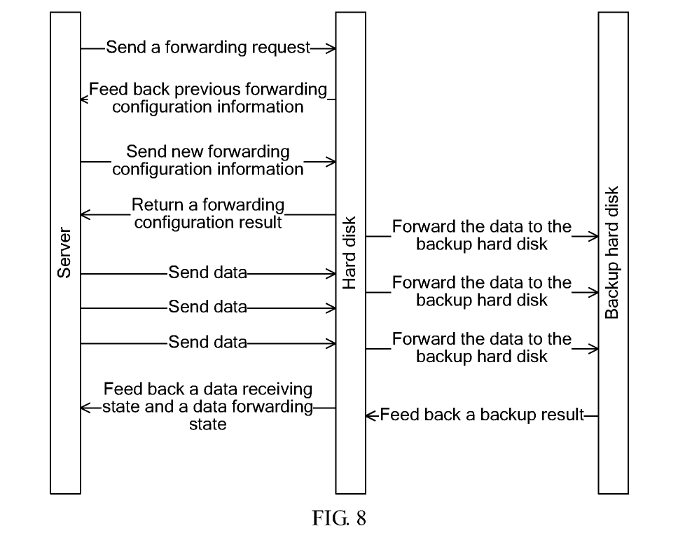

In this embodiment, as shown in FIG. 8, a hard disk forwards, in a synchronous forwarding mode, data received from a server, and a procedure is as follows.

At a server end, the server sends a forwarding request.

At a hard disk end, after receiving the forwarding request, the hard disk feeds back previous forwarding configuration information to the server.

At the server end, after receiving the previous forwarding configuration information, the server sends new forwarding configuration information.

At the hard disk end, after receiving the new forwarding configuration information, the hard disk returns a forwarding configuration result to the server.

At the server end, after receiving the forwarding configuration result, the server sends data.

At the hard disk end, at the same time when receiving the data, the hard disk forwards the data to a backup hard disk, and feeds back a state in which the hard disk receives the data and a state in which the hard disk forwards the data.

At the server end, the server receives the data receiving state and the data forwarding state fed back by the hard disk.

### Embodiment 2

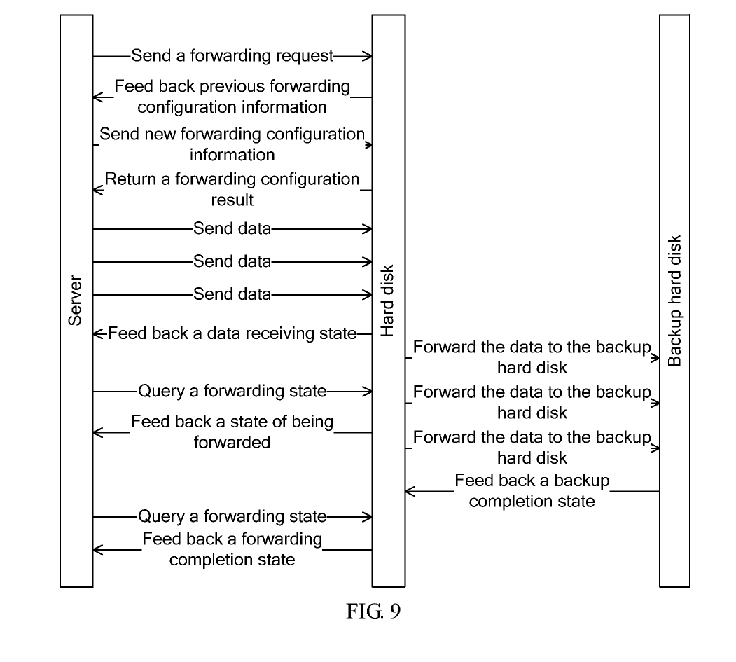

In this embodiment, as shown in FIG. 9, a hard disk forwards, in an asynchronous forwarding mode, data received from a server, and operations are as follows.

At a server end, the server sends a forwarding request.

At a hard disk end, after receiving the forwarding request, the hard disk feeds back previous forwarding configuration information to the server.

At the server end, after receiving the previous forwarding configuration information, the server sends new forwarding configuration information.

At the hard disk end, after receiving the new forwarding configuration information, the hard disk returns a forwarding configuration result to the server.

At the server end, after receiving the forwarding configuration result, the server sends data.

At the hard disk end, the hard disk receives the data and feeds back a receiving state to the server.

At the server end, the server receives the receiving state fed back by the hard disk.

At the hard disk end, the hard disk forwards the data to a backup hard disk.

At the server end, the server sends a forwarding status query request.

At the hard disk end, the hard disk receives the forwarding status query request and feeds back a forwarding state to the server.

At the server end, the server receives the forwarding state.

Persons of ordinary skill in the art may understand that, each aspect of the present invention or a possible implementation manner of each aspect may be specifically implemented as a system, a method, or a computer program product. Therefore, each aspect of the present invention or a possible implementation manner of each aspect may use forms of hardware only embodiments, software only embodiments (including firmware, resident software, and the like), or embodiments with a combination of software and hardware, which are uniformly referred to as “circuit”, “module”, or “system” herein. In addition, each aspect of the present invention or the possible implementation manner of each aspect may take a form of a computer program product, where the computer program product refers to computer-readable program code stored in a computer-readable medium.

The computer-readable medium may be a computer-readable signal medium or a computer-readable storage medium. The computer-readable storage medium includes but is not limited to an electronic, magnetic, optical, electromagnetic, infrared, or semi-conductive system, device, or apparatus, or any appropriate combination thereof, such as a random access memory (RAM), a read-only memory (ROM), an erasable programmable read only memory (EPROM or flash memory), an optical fiber, and a compact disc read only memory (CD-ROM).

A processor in a computer reads computer-readable program code stored in a computer-readable medium, so that the processor can perform a function and an action specified in each step or a combination of steps in a flowchart; and an apparatus is generated to implement a function and an action specified in each block or a combination of blocks in a block diagram.

All computer-readable program code may be executed on a user computer, or some may be executed on a user computer as a standalone software package, or some may be executed on a computer of a user while some is executed on a remote computer, or all the code may be executed on a remote computer or a server. It should also be noted that, in some alternative implementation solutions, each step in the flowcharts or functions specified in each block in the block diagrams may not occur in the illustrated order. For example, two consecutive steps or two blocks in the illustration, which are dependent on an involved function, may in fact be executed substantially at the same time, or these blocks may sometimes be executed in reverse order.

Obviously, persons skilled in the art can make various modifications and variations to the present invention without departing from the spirit and scope of the present invention. The present invention is intended to cover these modifications and variations provided that they fall within the scope of protection defined by the following claims and their equivalent technologies.

What is claimed is:

1. A hard disk, comprising:
a storage module configured to store data;
an interaction interface configured to implement data interaction between the hard disk and an external device; and
a data control module configured to control, using the interaction interface, the data interaction between the hard disk and the external device.

2. The hard disk according to claim 1, wherein the external device is an external computer.

3. The hard disk according to claim 1, wherein the external device is an external hard disk.

4. The hard disk according to claim 1, wherein the interaction interface is one of a Serial Attached Small Computer System (SAS) interface, a Serial Advanced Technology Attachment (SATA) interface, a Universal Serial Bus (USB) interface, and a wireless network interface.

5. The hard disk according to claim 1, wherein the interaction interface is an Internet Small Computer System Interface (iSCSI) and configured to receive, disassemble, assemble, and send iSCSI data.

6. The hard disk according to claim 1, wherein the data control module comprises a data forwarding unit configured to forward the data stored in the storage module to an external hard disk.

7. The hard disk according to claim 6, wherein the data forwarding unit further comprises:
a forwarding command receiving subunit configured to receive a forwarding request and forwarding configuration information;
a forwarding control subunit configured to control a data forwarding process; and
a forwarding status feedback subunit configured to feed back a state in which the hard disk forwards the data.

8. The hard disk according to claim 1, wherein the data control module comprises a data acquiring unit configured to acquire the data from the external device and store the data in the storage module.

9. A method for forwarding data implemented by a hard disk, comprising:
receiving the data;
storing the data; and
forwarding the data to an external device.

10. The method for forwarding the data implemented by the hard disk according to claim 9, further comprising a step of receiving a forwarding request and forwarding configuration information.

11. The method for forwarding the data implemented by the hard disk according to claim 9, further comprising a step of feeding back a state in which the hard disk forwards the data.

12. The method for forwarding the data implemented by the hard disk according to claim 9, wherein the data is forwarded to the external device at the same time when the data is stored.

13. The method for forwarding the data implemented by the hard disk according to claim 9, wherein the data is forwarded to the external device after the data is stored.

14. A method for acquiring data implemented by a hard disk, comprising:
receiving a data acquiring command;
establishing a data connection with an external device; and
acquiring the data.

15. The method for acquiring the data implemented by the hard disk according to claim 14, wherein the external device is an external hard disk.

16. The method for acquiring the data implemented by the hard disk according to claim 14, wherein the data acquiring command comprises a network address of the external device.
